(19) United States
(12) Patent Application Publication
(10) Pub. No.: US 2007/0152560 A1
(43) Pub. Date: Jul. 5, 2007

(54) Display front panel, and method for producing the same

(75) Inventors: Nobuo Naito, Tokyo-To (JP); Fumihiro Arakawa, Tokyo-To (JP); Tadahiro Masaki, Tokyo-To (JP)

Correspondence Address: OLIFF & BERRIDGE, PLC, P.O. BOX 19928, ALEXANDRIA, VA, 22320, US

(73) Assignee: DAI NIPPON PRINTING CO., LTD., Tokyo-To (JP)

(21) Appl. No.: 10/586,246

(22) PCT Filed: Jan. 19, 2005
(86) PCT No.: PCT/JP05/00608

§ 371 Date: Aug. 25, 2006

(30) Foreign Application Priority Data
Jan. 21, 2004 (JP) 2004-012527

(51) Int. Cl. H01J 29/88

(52) U.S. Cl. 313/479

(57) ABSTRACT

A method for producing a display front panel according to the present invention comprises the steps of (1) laminating a metal layer 21 to at least one surface of a transparent substrate 11 by a first transparent adhesive layer 13, thereby obtaining a laminate, (2) providing a mesh-patterned resist layer on a surface of the metal layer 21 of the laminate, etching the metal layer 21 to remove portions thereof that are not covered with the resist layer, and removing the resist layer, thereby forming a metal mesh layer 21 having a mesh part 103 with a plurality of openings 105, and a frame part 101 around the mesh part 103, and (3) laminating a near infrared ray shielding film 41 to the face of the mesh part 103 of the metal mesh layer 21 by a second transparent adhesive layer 33, and filling the surface irregularities R of the first adhesive layer 13 exposed at the openings 105 of the mesh part 103 with the second transparent adhesive layer 33 to make the exposed roughened surface R of the first adhesive layer 13 transparent.

### FIELD OF THE INVENTION

The present invention relates to a display front panel useful for preventing EMI (electromagnetic (wave) interference) that is caused by electromagnetic waves emitted from displays such as plasma display panels (hereinafter also referred to as PDPs) and for shielding NIR (near infrared rays) emitted from displays, and, more particularly, to a display front panel excellent in EMI prevention, NIR shielding properties, and transparency, produced by laminating a metal mesh layer to a transparent substrate by a transparent adhesive layer, in which the roughened surface of the adhesive layer exposed at the openings of the metal mesh layer is covered with another adhesive layer by which a near infrared ray shielding film is laminated to the metal mesh layer, and to a method for producing the display front panel.

In this Specification, “ratio”, “part”, “%”, and the like that indicate proportions are on a weight basis unless otherwise specified, and the symbol “/” denotes that layers described before and after this symbol are integrally laminated. “NIR”, “UV”, and “PET” are abbreviations, synonyms, functional expressions, common designations, or terms used in the art, which designate “near infrared rays”, “ultraviolet light”, and “polyethylene terephthalate”, respectively.

### BACKGROUND ART

Electromagnetic waves which electromagnetic equipment generates adversely affect another electromagnetic equipment and are said to have influences also on the human body and animals, and a variety of measures have already been taken to shield such electromagnetic waves. Particularly, PDPs that have recently come to be used generate electromagnetic waves with frequencies of 30 to 130 MHz, so that they can affect computers or computerized apparatuses placed near the PDPs. It is therefore desirable to shield, as much as possible, electromagnetic waves emitted from PDPs.

A PDP is an assembly composed of a glass plate having a data electrode and a fluorescent layer, and a glass plate having a transparent electrode, with a gas such as xenon or neon sealed in a space between the two glass plates. PDPs can be made large in screen size as compared with conventional displays using CRTs (cathode ray tubes), and are now being popularized. When operated, such PDPs generate a large amount of unwanted radiation including electromagnetic waves, near infrared rays, unwanted light with specific wavelengths, and heat. In order to shield or control these electromagnetic waves, near infrared rays, and unwanted light with specific wavelengths, a plasma display front panel is usually mounted on the front of a PDP that constitutes a plasma display. Such a plasma display front panel is particularly required to have electromagnetic wave shielding properties and near infrared ray shielding properties.

In general, display front panels are required to have an efficiency (function) of 30 dB or more in shielding electromagnetic waves with frequencies of 30 MHz to 1 GHz that are emitted from display elements. They are also required to shield near infrared rays with wavelengths of 800 to 1,100 nm emitted from display elements because these rays cause malfunction of remotely controlled apparatus such as VTRs, and infrared communications equipment.

Further, display front panels are required to have moderate transparency (the property of transmitting visible light) and brightness, as well as various functions such as a function of enhancing image visibility by imparting, to displays, the property of preventing reflection and glaring of extraneous light, and a function of increasing mechanical strength.

Particularly, if display front panels have exposed roughened surfaces, or contain fine air bubbles that have been incorporated in the course of their fabrication, they irregularly reflect light to increase haze. Such display front panels may lower image contrast when mounted on displays such as PDPs. Display front panels are, therefore, also required to have such transparency that they do not impair display visibility.

In a conventional method for producing a display front panel, each layer such as a layer having the function of preventing electromagnetic wave interference (EMI) and a layer having the function of shielding near infrared rays (NIR) is formed on each side of a transparent substrate, made of a fragile glass plate, large in area, and heavy in weight, while the transparent substrate is turned over. Therefore, the production of a display front panel has been difficult, has demanded a large number of steps, and has been costly. For this reason, there is a demand for a method for producing a display front panel by which a highly accurate display front panel can be stably and inexpensively produced in a smaller number of steps by using the existing facilities and techniques, and by which the display front panel can be mounted on a display with ease.

Furthermore, in order to further enhance the property of shielding electromagnetic waves, display front panels are required to have, in the frame parts of their metal mesh layers, exposed faces for grounding.

However, there have so far been no display front panels that meet all of the requirements that are practical levels of electromagnetic wave shielding properties, near infrared ray shielding properties, displayed image quality, displayed image visibility, mechanical strength, and ease of production.

A transparent, electrically-conductive, electromagnetic wave shielding sheet, produced by forming a transparent indium tin oxide (abbreviation: ITO) film on a transparent film, has been proposed as an electromagnetic wave shielding sheet having both seeing through properties and electromagnetic wave shielding properties (see Japanese Patent Laid-Open Publications No. 278800/1989 and No. 323101/1993, for example). However, such an electromagnetic wave shielding sheet is disadvantageous in that it is insufficient in electrical conductivity and is lacking in the property of shielding electromagnetic waves.

To overcome the above shortcoming, there has recently been proposed an electromagnetic wave shielding sheet that is produced by laminating, to a transparent film, a metal mesh obtained by etching a metal foil (metal layer) (see Japanese Patent Laid-Open Publications No. 119675/1999 and No. 210988/2001, for example). Such a metal mesh has the ability to shield electromagnetic waves high enough to shield strong electromagnetic waves emitted from PDPs, but has no ability to shield near infrared rays. Further, since such a metal mesh is usually produced by laminating a metal foil and a transparent substrate with a layer of an adhesive (adhesive layer) and by photolithographically making the metal foil into a mesh, the surface irregularities of the metal foil are transferred to the surface of the adhesive layer exposed at the openings of the metal mesh to roughen the surface. Moreover, fine air bubbles tend to be incorporated in the adhesive layer in the course of the laminating of the metal foil and the transparent substrate. The air bubbles incorporated in such a way decrease the adhesive force of the adhesive layer, and irregularly reflect light to lower the contrast of an image displayed on a display such as a PDP, viewed from the transparent substrate side.

In order to lessen the above-described roughness of the adhesive layer exposed at the openings of the metal mesh, Japanese Patent No. 3473310 proposes such a metal mesh as is shown in FIG. 6, having additionally the effect of shielding near infrared rays. As shown in FIG. 6(A), a metal layer 21 is laminated to a transparent substrate 11 by a layer of a transparent adhesive (adhesive layer) 13, and only portions of the metal layer 21 that correspond to openings 105 are photolithographically removed; the remaining metal layer forms a metal mesh layer 21 composed of a mesh part 103 consisting of line parts 107, and a frame part 101 for grounding, surrounding the mesh part 103. Subsequently, as shown in FIG. 6(B), a resin that differs in refractive index by 0.14 or less from the adhesive layer 13 is applied to the mesh part 103 of the metal mesh layer 21 to form a resin layer 30, in order to fill the openings 105 of the mesh part 103 with the resin layer 30, and, at the same time, in order to optically eliminate the roughened surface R of the adhesive layer 13 exposed at the openings 105, thereby preventing clouding and decrease in contrast, caused by irregular reflection of light and decrease in contrast. Thereafter, as shown in FIG. 6(C), a coating containing a near infrared absorber is applied to the transparent resin layer 30 to form thereon a near infrared ray shielding film 40. In this method, however, since the resin is applied to the metal mesh layer 21 having surface irregularities, as shown in FIG. 6(B), it is not easy to make the surface of the resin film perfectly smooth. Consequently, the transparent resin layer 30 is to have, on its surface, winding patterns WP that are the reflection of the surface irregularities of the metal mesh layer 21. Further, the near infrared ray shielding film 40 formed by applying the coating to the surface of the transparent resin layer 30 also becomes non-uniform in thickness (has thickness distribution). There has, therefore, been a problem that the near infrared ray absorptive power becomes non-uniform as well.

Further, in electromagnetic wave shielding components that are used as display front panels, there have been known electromagnetic wave shielding adhesive films that can be satisfactorily connected to external electrodes for grounding and that are excellent in electromagnetic wave shielding properties, infrared ray shielding properties, transparency, and non-recognizability, as well as components using such electromagnetic wave shielding adhesive films (see Japanese Patent Laid-Open Publications No. 15533/2003, No. 66854/2003, and No. 324431/2002, for example). However, to produce the display front panel described in Japanese Patent Laid-Open Publication No. 15533/2003, it is necessary to make a terminal area for grounding by removing the upper layer by a laser beam or the like. To produce the display front panel described in Japanese Patent Laid-Open Publication No. 66854/2003, it is necessary to make a terminal area by removing only one upper layer on the edge of the front panel. To produce the display front panel described in Japanese Patent Laid-Open Publication No. 324431/2002, it is necessary to make an electrode (terminal area) by means of a silver paste or a conductive tape. The display front panels described in these patent publications are thus disadvantageous in that the step of making a terminal area is additionally needed for production, and that this step demands additional equipment and materials, which leads to increase in cost.

### SUMMARY OF THE INVENTION

The present invention was accomplished in order to solve the above-described problems in the prior art. An object of the present invention is, therefore, to provide a display front panel comprising a transparent substrate and a metal mesh layer laminated to the transparent substrate by a transparent adhesive layer, having the property of preventing EMI and the property of shielding NIR, being uniform in the ability to shield NIR, causing no irregular reflection of light by the adhesive layer exposed at the openings of the metal mesh layer, having transparency so as not to impair display visibility; and to provide a method for producing the display front panel.

Another object of the present invention is to provide a display front panel having, in the frame part of its metal mesh layer, an exposed surface for grounding, and to provide a method for producing such a display front panel.

In order to fulfill the above-described objects, the present invention provides a method for producing a display front panel comprising a transparent substrate, a metal mesh layer laminated to at least one surface of the transparent substrate by a first transparent adhesive layer, and a near infrared ray shielding film laminated to the surface of the metal mesh layer by a second transparent adhesive layer, comprising the steps of (1) laminating a metal layer to at least one surface of a transparent substrate by a first transparent adhesive layer, thereby obtaining a laminate, (2) providing a mesh-patterned resist layer on the metal layer face of the laminate, etching the metal layer to remove portions thereof that are not covered with the resist layer, and removing the resist layer, thereby forming a metal mesh layer having a mesh part with a plurality of openings, and a frame part around the mesh part, and (3) laminating a near infrared ray shielding film to the face of the mesh part of the metal mesh layer by a second transparent adhesive layer, and filling the surface irregularities of the first adhesive layer exposed at the openings of the mesh part with the second adhesive layer to make the exposed roughened surface of the first adhesive layer transparent.

In the method for producing a display front panel according to the present invention, it is preferred that both the laminating of the metal layer to the transparent substrate and the laminating of the near infrared ray shielding film to the metal layer be conducted by dry laminating wherein continuous films are laminated by a winding-up loading and unloading system. Further, in laminating the near infrared ray shielding film to the metal layer face by the winding-up loading and unloading system, it is preferable to expose at least one edge section of the frame part of the metal layer by making a width of the near infrared ray shielding film smaller than that of the metal layer in the laminate film, wherein the width refers to a size in a direction perpendicular to a direction in which the near infrared ray shielding film and the laminate film containing the metal layer are running.

The present invention also provides a display front panel comprising a transparent substrate, a metal mesh layer laminated to at least one surface of the transparent substrate by a first transparent adhesive layer, and a near infrared ray shielding film laminated to a surface of the metal mesh layer by a second transparent adhesive layer, the metal mesh layer having a mesh part with a plurality of openings, the second adhesive layer filling surface irregularities of the first adhesive layer exposed at the openings of the mesh part to make the exposed roughened surface of the first adhesive layer transparent.

In the display front panel according to the present invention, it is preferred that the metal mesh layer further has a frame part around the mesh part, and that at least one edge section of the frame part be exposed without being covered with the near infrared ray shielding film.

By the method for producing a display front panel according to the present invention, a highly accurate display front panel having the property of preventing EMI and the property of shielding NIR, being uniform in the ability to shield NIR, causing no irregular reflection of light by the adhesive layer exposed at the openings of the metal mesh layer, and having transparency so as not to impair display visibility, can be stably and inexpensively produced in a small number of steps by the use of the existing facilities and techniques.

Further, according to the method for producing a display front panel of the present invention, it is preferred that both the laminating of the metal layer to the transparent substrate and the laminating of the near infrared ray shielding film to the metal layer be conducted by dry laminating wherein continuous films are laminated by the winding-up loading and unloading system. If dry laminating is employed, it is possible to produce, with high productivity and high yield, a display front panel by the use of the existing facilities and techniques, in a continuous process of the winding-up loading and unloading system.

Furthermore, according to the method for producing a display front panel of the present invention, in laminating the near infrared ray shielding film to the metal layer face by the winding-up loading and unloading system, it is preferable to expose at least one edge section of the frame part of the metal layer by making a width of the near infrared ray shielding film smaller than that of the metal layer in the laminate film, wherein the width refers to a size in a direction perpendicular to a direction in which the near infrared ray shielding film and the laminate film containing the metal layer run. By doing so, it is possible to easily make, in the frame part of the metal layer, an exposed area useful for grounding, without separately conducting a step of peeling and removing a coating, a film, or the like from the frame part of the metal layer. Moreover, the display front panel can be mounted on a display with ease.

On the other hand, according to the present invention, there is provided a display front panel comprising a transparent substrate and a metal mesh layer laminated to the transparent substrate by a transparent adhesive layer, having the property of preventing EMI and the property of shielding NIR, being uniform in the ability to shield NIR even when the first adhesive layer has some surface irregularities, causing no irregular reflection of light by the adhesive layer exposed at the openings of the metal mesh layer, and having transparency so as not to impair display visibility.

Further, according to the display front panel of the present invention, it is preferred that at least one edge section of the frame part of the metal mesh layer be exposed for grounding. By doing so, it becomes possible to ground the display front panel to further enhance the ability, of the display front panel, to shield electromagnetic waves, and, moreover, the display front panel can be mounted on a display with ease.

### BRIEF DESCRIPTION OF THE DRAWINGS

FIG. 1 is a plan view showing a display front panel according to an embodiment of the present invention;

FIG. 2 is a perspective view showing the mesh part of the metal mesh layer in the display front panel shown in FIG. 1;

FIG. 3 is a sectional view showing a main part of the display front panel according to the embodiment of the present invention;

FIG. 4 is a sectional view showing a modified metal layer for use in a display front panel according to an embodiment of the present invention;

FIG. 5 are sectional views of a main part of a display front panel for explaining a method for producing a display front panel according to an embodiment of the present invention; and

FIG. 6 are sectional views of a main part of a display front panel for explaining a conventional method for producing a display front panel.

### BEST MODE FOR CARRYING OUT THE INVENTION

Embodiments of the present invention will be described hereinafter with reference to the accompanying drawings.

A method for producing a display front panel according to an embodiment of the present invention will be firstly explained with reference to FIG. 5.

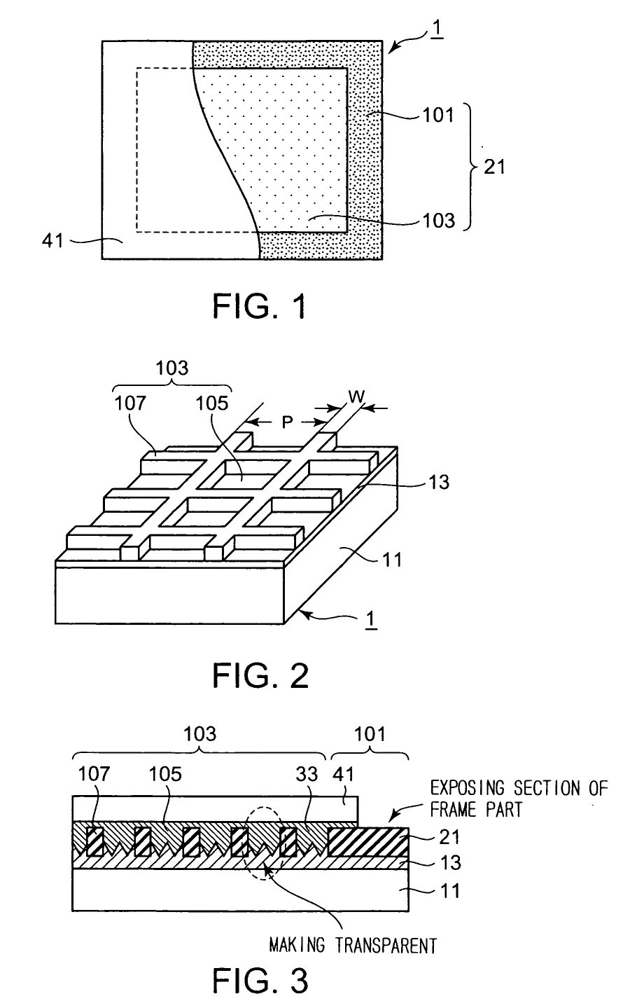

As shown in FIG. 5, a method for producing a display front panel according to this embodiment comprises the steps of (1) laminating a metal layer 21 to at least one surface of a transparent substrate 11 by a layer of a transparent adhesive (first adhesive layer) 13, thereby obtaining a laminate (FIG. 5(A)), (2) providing a mesh-patterned resist layer on a surface of the metal layer 21 of the laminate, etching the metal layer 21 to remove portions thereof that are not covered with the resist layer, and removing the resist layer, thereby forming a metal mesh layer 21 having a mesh part 103 consisting of a plurality of line parts 107 and a plurality of openings 105, and a frame part 101 around the mesh part 103 (see FIG. 1, a plan view) (FIG. 5(B)), and (3) laminating a preformed near infrared ray shielding film 41 to surfaces of the mesh part 103 and the frame part 101 of the metal mesh layer 21 by a layer of a transparent adhesive (second adhesive layer) 33, and filling, with the second adhesive layer 33, surface irregularities R of the first adhesive layer 13 exposed at the openings 105 of the mesh part 103 to optically eliminate the exposed roughened surface R of the first adhesive layer 13, thereby making the roughened surface R transparent (FIG. 5(C)).

In the method for producing a display front panel according to this embodiment, it is preferred that both the laminating of the metal layer 21 to the transparent substrate 11 and the laminating of the near infrared ray shielding film 41 to the metal layer 21 be conducted by dry laminating wherein continuous films are laminated by a winding-up loading and unloading system. Further, in this process, it is preferred that at least one edge section of the frame part 101 of the metal layer 21 be exposed by making a width of the near infrared ray shielding film 41 smaller than that of the metal layer 21 in the laminate film, wherein the width refers to a size in a direction perpendicular to a direction in which the near infrared ray shielding film 41 and the laminate film containing the transparent substrate 11 and the metal layer 21 are running (see FIG. 3).

The display front panel 1 produced by the above-described production method comprises, as shown in FIGS. 1 to 3, the transparent substrate 11, the metal mesh layer 21 laminated to at least one surface of the transparent substrate 11 by the first transparent adhesive layer 13, and the near infrared ray shielding film 41 laminated to the surfaces of the mesh part 103 and the frame part 101 of the metal mesh layer 21 by the second transparent adhesive layer 33.

As shown in FIGS. 1 to 3, the metal mesh layer 21 has the mesh part 103 consisting of a plurality of line parts 107 and a plurality of openings 105, and the frame part 101 around the mesh part 103; and the second adhesive layer 33 fills the surface irregularities of the first adhesive layer 13 exposed at the openings 105 of the mesh part 103 to make the exposed roughened surface R of the first adhesive layer 13 transparent. Further, as shown in FIG. 3, at least one edge section of the frame part 101 of the metal layer 21 is exposed without being covered with the near infrared ray shielding film 41. In FIG. 2, the second adhesive layer 33 and the near infrared ray shielding film 41 are omitted for easy understanding of the construction of the mesh part 103 of the metal layer 21.

The details of the method for producing a display front panel according to this embodiment will be described by explaining successively the above-described steps in the production method, along with materials to be used in the respective steps.

[First Step]

The first step shown in FIG. 5(A) is the step of laminating a metal layer 21 to a transparent substrate 11 by a layer of a transparent adhesive (first adhesive layer) 13, thereby obtaining a laminate.

(Transparent Substrate)

A variety of materials having transparency, insulating properties, heat resistance, mechanical strength, and so on good enough to withstand service conditions and production conditions can be used for the transparent substrate 11. Examples of materials useful herein include glass and transparent resins.

Of the materials useful for the transparent substrate 11, glass includes silica glass, borosilicate glass, and soda-lime glass, and it is preferable to use non-alkali glass which contains no alkali components and which has a low rate of thermal expansion and is excellent in dimensional stability and also in working properties in high-temperature heat treatment. If such non-alkali glass is used, the transparent substrate can be made to serve also as a substrate for an electrode.

On the other hand, transparent resins useful for the transparent substrate 11 include polyester resins such as polyethylene terephthalate, polybutylene terephthalate, polyethylene naphthalate, terephthalic acid-isophthalic acid-ethylene glycol copolymers, and terephthalic acid-cyclohexane dimethanol-ethylene glycol copolymers; polyamide resins such as nylon 6; polyolefin resins such as polypropylene and polymethyl pentene; acrylic resins such as polymethyl methacrylate; styrene resins such as polystyrene and styrene-acrylonitrile copolymers; cellulose resins such as triacetyl cellulose; imide resins; and polycarbonate. A sheet, film, plate or the like of any of these resins can be used as the transparent substrate.

The transparent-resin-made transparent substrate 11 may be made from a copolymer resin or mixture (including an alloy) containing, as a main component, any of the above-enumerated resins, and may also be a laminate of two or more layers. Such a transparent substrate 11 may be either an oriented or non-oriented film; however, in order to obtain increased strength, it is preferable to use a mono- or bi-axially oriented film.

Generally, it is preferred that the transparent substrate 11 made from a transparent resin has a thickness of approximately 12 to 1000 μm, more preferably 50 to 700 μm, optimally 100 to 500 μm. On the other hand, approximately 1000 to 5000 μm is generally proper for the thickness of the transparent substrate made of glass. In either case, a transparent substrate with a thickness smaller than the above range cannot have sufficiently high mechanical strength, so that it curls, becomes wavy, or is broken; while a transparent substrate with a thickness greater than the above range has excessively high strength, which is wasteful from the viewpoint of cost.

In general, a film of a polyester resin such as polyethylene terephthalate or polyethylene naphthalate, a cellulose resin film, or a glass plate is conveniently used as the transparent substrate 11 because it is excellent in both transparency and heat resistance and is also inexpensive. Of these materials, a polyethylene terephthalate film is most preferred because it is hard to break, is light in weight, and is easy to form. A transparent substrate having higher transparency is more useful, and the preferred transparency of the transparent substrate, as expressed as a transmittance for visible light, is 80% or more.

Prior to the application of an adhesive, the transparent substrate 11 (e.g., a transparent substrate film) to be coated with the adhesive may be subjected to adhesion-promoting treatment such as corona discharge treatment, plasma treatment, ozone treatment, flame treatment, primer (also referred to as anchoring, adhesion-promoting or adhesion-improving agent) coating treatment, preheating treatment, dust-removing treatment, vacuum deposition, or alkali treatment. Additives such as ultraviolet light absorbers, fillers, plasticizers, and antistatic agents may be optionally incorporated in transparent resin films useful for the transparent substrate 11 or the like.

(Metal Layer)

Metals having electrical conductivity good enough to satisfactorily shield electromagnetic waves, such as gold, silver, copper, iron, nickel, and chromium, may be used as a material for the metal layer 21. The metal layer 21 may be a layer of not only a single metal but also an alloy, and it may also be composed of either a single layer or multiple layers. Specifically, low-carbon steels such as low-carbon rimmed steels and low-carbon aluminum killed steels, Ni—Fe alloys, and invar alloys are herein preferred as iron materials. If cathodic electrodeposition is conducted as a blackening treatment, it is preferable to use a copper foil or a copper alloy foil as a metal layer because it is easy to electrodeposit a blackening layer on such a material.

Although it is possible to use both rolled copper foil and electrolytic copper foil as the copper foil, electrolytic copper foil is preferred because of its uniformity in thickness and of excellent adhesion to a layer formed by blackening treatment and/or chromate treatment and because it can have a thickness as small as below 10 μm.

The thickness of the metal layer 21 is approximately from 1 to 100 μm, and preferably from 5 to 20 μm. If the metal layer 21 has a thickness smaller than the above range, although it can be photolithographically processed into a mesh with ease, it has an increased electrical resistance value and thus has impaired electromagnetic wave shielding effect. On the other hand, when the metal layer 21 has a thickness in excess of the above range, it cannot be made into the desired fine mesh. Consequently, the mesh has a decreased substantial opening rate and a decreased light transmittance, which leads to decrease in viewing angle and to deterioration of image visibility.

For the metal layer 21, a metal layer having a surface with such surface roughness that a mean surface roughness value of 10 measurements, Rz, obtained in accordance with JIS-B0601 (1994 version) is from 0.5 to 10 μm has been favorably used so far. This is because if the metal layer 21 has surface roughness higher than the above one, an adhesive or resist, upon application thereof, does not spread over the entire surface, or causes incorporation of air to contain air bubbles. However, according to the present invention, a metal layer with any surface roughness can be used as the metal layer 21. Of course, it is more effective to use a metal layer 21 with such surface roughness that the Rz value is from 0.5 to 10 μm.

(Blackening Layer)

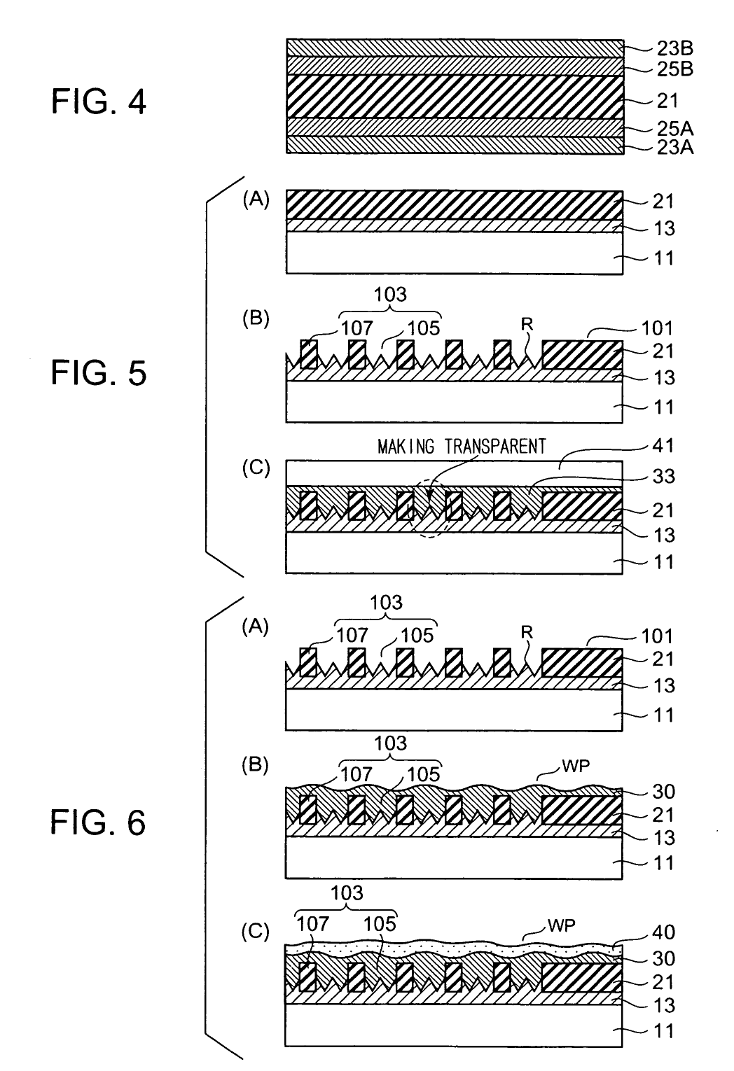

In this embodiment, the above-described metal layer having, on at least one surface thereof, a blackening layer and/or an anticorrosive layer and other optional layers may be used as the metal layer 21. Specifically, there may be used a metal layer 21 having, on each side, a blackening layer and an anticorrosive layer (a laminate of an anticorrosive layer 23A/a blackening layer 25A/a metal layer 21/a blackening layer 25B/an anticorrosive layer 23B), as shown in FIG. 4.

Of these layers, the blackening layers 25A, 25B are layers that are obtained by subjecting the surfaces of the metal layer 21 to roughening treatment and/or blackening treatment. For the blackening treatment, any method wherein a metal, alloy, metal oxide, or metal sulfide is deposited by a variety of techniques may be employed. Preferred methods useful for conducting the blackening treatment include plating. Plating makes it possible to form a blackening layer on the metal layer 21 with good adhesion and to uniformly blacken the surface of the metal layer 21 with ease. At least one metal selected from copper, cobalt, nickel, zinc, molybdenum, tin, and chromium, or a compound thereof may be used as a material for the plating. When the other metals or compounds are used, the metal layer 21 cannot be fully blackened, or the adhesion of the blackening layer to the metal layer 21 is insufficient. These problems occur significantly in a case wherein cadmium is used for plating, for example.

A plating process that is favorably employed when a copper foil is used as the metal layer 21 is cathodic electrodeposition plating, in which the copper foil is subjected to cathodic electrolysis in an electrolyte such as sulfuric acid, copper sulfate, or cobalt sulfate, thereby depositing cationic particles on the copper foil. The cationic particles deposited on the surface of the metal layer 21 in the above-described manner roughen this surface more greatly, and, at the same time, make the metal layer black in color. Although copper particles as well as particles of alloys of copper and other metals may be used as the cationic particles, it is herein preferable to use copper-cobalt alloy particles. The mean particle diameter of the copper-cobalt alloy particles is preferably from 0.1 to 1 μm. The cathodic electrodeposition described above is convenient to deposit uniformly sized particles with a mean particle diameter of 0.1 to 1 μm. Further, if treated at high current density, the surface of the copper foil becomes cathodic and generates reducing hydrogen to get activated, so that significantly improved adhesion can be obtained between the copper foil and the particles.

If the mean particle diameter of the copper-cobalt alloy particles is made outside the above-described range, the following problem occurs. When the mean particle diameter of the copper-cobalt alloy particles is made greater than the above range, the metal layer is not satisfactorily blackened, and, moreover, falling of the deposited particles (also referred to as falling of the powdery coating) easily occurs. In addition, the external appearance of the agglomerated particles becomes poor in denseness, and the appearance and light absorption become noticeably non-uniform. On the other hand, copper-cobalt alloy particles with a mean particle diameter smaller than the above-described range are also insufficient in the ability to blacken the metal layer and cannot fully prevent reflection of extraneous light to lower image visibility.

(Anticorrosive Layers)

The anticorrosive layers 23A, 23B have the function of protecting the surfaces of the metal layer 21 and the blackening layers 25A, 25B from corrosion. In addition, if particles are used to form the blackening layers 25A, 25B (blackening treatment), the anticorrosive layers 23A, 23B prevent falling or deformation of the particles, and, moreover, make the blackening layers 25A, 25B blacker. In a period before the metal layer 21 is laminated to the transparent substrate 11, it is necessary to prevent the particles of the blackening layers 25A, 25B from falling and degradation, so that the anticorrosive layers 23A, 23B are needed to be formed before laminating the metal layer 21 to the transparent substrate 11.

Conventional anticorrosive layers may be used as the anticorrosive layers 23A, 23B, and metals such as chromium, zinc, nickel, tin, and copper, alloys thereof, and oxides of these metals are useful as a material for the anticorrosive layers 23A, 23B. Preferably, chromium compound layers obtained by conducting plating with zinc, followed by chromate treatment, are used as the anticorrosive layers 23A, 23B. In order to increase resistance to acids that is needed when etching and washing with an acid are conducted, it is preferable to incorporate a silicon compound in the anticorrosive layers 23A, 23B, and such a silicon compound include a silane-coupling agent. The anticorrosive layers 23A, 23B made from the above-described materials are also excellent in adhesion to the blackening layers 25A, 25B (especially, a copper-cobalt alloy particle layer) and to the first adhesive layer 13 (especially, a two-pack curable urethane resin adhesive).

A conventional plating process may be used to form a layer of any of the above-described metals such as chromium, zinc, nickel, tin, and copper, alloys thereof, and oxides of these metals. To form a chromium compound layer, conventional plating or chromate (chromic acid salt) treatment may be conducted, for example. One side of the blackened substrate may be subjected to chromate treatment that is conducted by coating or flow coating, or both sides of the blackened substrate may be simultaneously subjected to chromate treatment that is conducted by dipping.

The thickness of the anticorrosive layers 23A, 23B is approximately 0.001 to 10 μm, preferably 0.01 to 1 μm.

(Chromate Treatment)

Chromate treatment is that a chromate treatment liquid is applied to a material to be treated. To apply a chromate treatment liquid, roll coating, curtain coating, squeeze coating, electrostatic spraying, dip coating, or the like may be employed, and the chromate treatment liquid applied is dried without being washed with water. An aqueous solution containing chromic acid is usually used as the chromate treatment liquid. Specific examples of chromate treatment liquids useful herein include Alsurf 1000 (trade name of a chromate treatment liquid manufactured by Nippon Paint Co., Ltd., Japan), and PM-284 (trade name of a chromate treatment liquid manufactured by Nippon Parkerizing Co., Ltd., Japan).

It is preferable to conduct zinc plating prior to the above-described chromate treatment. If zinc plating is so conducted, the blackening layer/the anticorrosive layer (two layers of zinc layer/chromate treatment layer) is obtained, and this structure can bring about further enhancement of interlaminar bonding, anticorrosion, and blackening effect.

(Method of Laminating)

The transparent substrate 11 and the metal layer 21 are laminated with a layer of a transparent adhesive (first adhesive layer) 13, and the cross section of this laminate is shown in FIG. 5(A). This process of laminating is as follows: an adhesive resin is made into a latex, an aqueous dispersion, or an organic solvent solution, which is then printed on or applied to the surface of the transparent substrate 11 and/or the metal layer 21 by a conventional printing or coating method such as screen printing, gravure printing, comma coating, or roll coating, and is dried, if necessary; on this adhesive layer is superposed the other member, and pressure is exerted. The thickness of such a first adhesive layer 13 (when dried) is about 0.1 to 20 μm, preferably 1 to 10 μm. It is preferred that the first adhesive layer 13 be transparent and that the difference in refractive index between the first adhesive layer 13 and the second adhesive layer 33 be as small as possible. Specifically, it is preferred that the difference in refractive index between the first adhesive layer 13 and the second adhesive layer 33 be 0.14 or less.

Specifically, after applying an adhesive to the surface of the metal layer 21 and/or the transparent substrate 11 and drying the adhesive applied, the other member is superposed on the adhesive layer, and pressure is then exerted. Preferably, the two layers are laminated by a method that is called dry laminating by those skilled in the art.

(Dry Laminating)

Dry laminating is a method of laminating two members in the following manner: by a coating method such as a roll, reverse roll, or gravure coating, an adhesive dispersed or dissolved in a solvent is applied to one of the two members to form a film so that the film after dried has a thickness of approximately 0.1 to 20 μm, preferably 1 to 10 μm, and the solvent is evaporated, thereby forming an adhesive layer; immediately after forming the adhesive layer, the other laminating member is superposed on the adhesive layer; and this laminate is aged at 30 to 80° C. for several hours to several days, as needed, to cure the adhesive. The material for the adhesive layer useful in this dry laminating includes thermosetting adhesives and adhesives that cure in ionizing radiation such as ultraviolet light (UV) or electron beams (EB).

Specific examples of thermosetting adhesives useful herein include two-pack curable urethane adhesives obtainable by the reaction of polyfunctional isocyanates such as tolylene diisocyanate or hexamethylene diisocyanate with hydroxyl-group-containing compounds such as polyether polyols or polyacrylate polyols; acrylic adhesives; and rubber adhesives. Of these, two-pack curable urethane adhesives are preferred. In a case where a thermosetting adhesive is used, after laminating the two members, the bonding of the members is completed by curing the adhesive in an environment of a room temperature or a raised temperature.

On the other hand, in a case where an ionizing radiation curing resin that cures (reacts) in ionizing radiation such as ultraviolet light (UV) or electron beams (EB) is used as the adhesive, after laminating the two members with a layer of such an adhesive, the bonding of the members is completed by curing the adhesive by applying thereto ionizing radiation.

[Second Step]

The second step shown in FIG. 5(B) is the step of photolithographically making, into a mesh pattern, the metal layer 21 laminated to the transparent substrate 11.

(Photolithography)

A metal mesh layer 21 that serves as an electromagnetic wave shielding layer is formed by: photolithographically forming a mesh-patterned resist layer on the surface of the metal layer 21 of the laminate, etching the metal layer 21 to remove portions thereof that are not covered with the resist layer, and stripping the resist layer.

The metal mesh layer 21 formed in the above-described manner has a mesh part 103 and a frame part 101 around the mesh part 103, as shown in FIG. 1, a plan view. Further, as shown in FIG. 2, a perspective view, and in FIG. 3, a sectional view, the mesh part 103 consists of a plurality of line parts 107 (the remaining parts of the metal layer) and a plurality of openings 105 defined by the line parts 107. The frame part 101 entirely consists of the remaining metal layer having no openings. The frame part 101 is optional and may be provided so that it surrounds the mesh part 103 or stretches in at least a part of the area surrounding the mesh part 103.

Also in this second step, a belt-shaped laminate in the state of a continuously wound-up roll is processed. Namely, while feeding such a laminate either continuously or intermittently under a stretched and non-loosened state, masking, etching, and resist stripping are conducted.

(Masking)

Masking is conducted in the following manner, for example: first, a photosensitive resist is applied to the metal layer 21 and is dried; this resist layer is subjected to contact exposure, using an original plate with a predetermined pattern (a pattern corresponding to the line parts 107 of the mesh part 103 and the frame part 101); thereafter, development with water, film-hardening treatment, and baking are conducted. The resist is applied in the following manner: while continuously or intermittently unwinding and feeding the belt-like laminate in the state of a continuously wound-up roll, a resist made from casein, PVA, or gelatin is applied to the metal layer 21 of the laminate by such a method as dipping (immersion), curtain coating, or flow coating. Alternatively, a dry film resist may be used as the resist; the use of a dry film resist can improve working efficiency. When casein is used for the resist, the above-described baking is usually conducted in a heated environment, and, in this case, it is desirable to conduct the baking at a temperature as low as possible in order to prevent the laminate from curling.

(Etching)

The etching of the laminate is conducted after masking the laminate in the above-described manner. Since the laminate is etched continuously in this embodiment, it is preferable to use, as an etchant, a ferric or cupric chloride solution that can be readily circulated.

The etching of the laminate can be conducted by the use of equipment and processes that are basically the same as those for use in the production of shadow masks for cathode ray tubes of color TVs, in which belt-shaped continuous steel stock (especially a thin plate with a thickness of 20-80 μm) is etched. It is thus possible to use, for etching the laminate, the existing facilities for the production of shadow masks, and to continuously conduct a series of the steps of from masking to etching, so that the production efficiency is extremely high.

The laminate etched in the above-described manner is subjected to washing with water, stripping of the resist with an alkaline solution, and cleaning, and is then dried.

(Mesh Part)

The mesh part 103 of the metal mesh layer 21 is an area surrounded by the frame part 101. The mesh part 103 has line parts 107 that define a plurality of openings 105. There are no limitations on the shape of the openings 105 (mesh pattern), and examples of the shape of the openings 105 useful herein include triangles such as equilateral triangles, squares such as regular squares, rectangles, rhombuses, and trapezoids, polygons such as hexagon, circles, and ovals. The mesh part 103 may have openings that are a combination of openings in two or more different shapes.

From the viewpoint of the opening rate of the mesh part 103 and the non-recognizability of this part, it is preferred that the line width W of the line parts 107 of the mesh part 103 (see FIG. 2) be 50 μm or less, preferably 20 μm or less. From the viewpoint of light transmittance, it is preferred that the distance between the lines (line pitch) P in the line parts 107 (see FIG. 2) be 125 μm or more, preferably 200 μm or more. The opening rate is preferably 50% or more. In order to avoid the occurrence of moiré fringes or the like, the bias angle (the angle between the line parts 107 of the mesh part 103 and the sides (edges) of the display front panel 1 (electromagnetic wave shielding sheet)) may be properly selected with consideration for the pixel and emission properties of a display.

As shown in FIG. 5(B), the surface of the first adhesive layer 13 exposed at the openings 105 of the mesh part 103 is roughened (transferred) by the surface irregularities of those portions of the metal layer 21 that have been removed by etching, and remains as a roughened surface R. Such a roughened surface R irregularly diffuses light to increase haze, and if a front panel with such a roughened surface is mounted on a display such as a PDP, the contrast of an image displayed on the display is lowered, and the image visibility is thus impaired.

[Third Step]

The third step shown in FIG. 5(C) is the step of laminating a preformed near infrared ray shielding film 41 to the faces of the mesh part 103 and the frame part 101 of the metal mesh layer 21 by a layer of a transparent adhesive (second adhesive layer) 33.

(Method of Laminating)

The material for the second adhesive layer 33 and the method of laminating the near infrared ray shielding film 41 to the metal layer 21 may be the same as the material for the first adhesive layer 13 and the method of laminating the metal layer 21 to the transparent substrate 11, respectively.

A two-pack curable urethane adhesive is preferred for the second adhesive layer 33. Further, for optically eliminating the roughened surface R of the first adhesive layer 13 exposed at the openings 105 of the mesh part 103 of the metal layer 21, it is desirable that the difference in refractive index between the first adhesive layer 13 and the second adhesive layer 33 be as small as possible, preferably 0.14 or less. Such a small difference in refractive index can be readily attained if the same adhesive is used to form the first adhesive layer 13 and the second adhesive layer 33.

Dry laminating is a preferred method of laminating the near infrared ray shielding film 41 to the metal layer 21.

To cover at least the mesh part 103 of the metal layer 21 with the second adhesive layer 33 suffices for the purpose, and, in the step of dry-laminating the near infrared ray shielding film 41 to the metal layer 21, only the mesh part 103 may be coated with an adhesive by intermittent coating. By applying an adhesive in such a manner, it is possible to expose at least one edge section (usually four edge sections) of the frame part 101 of the metal layer 21. In this case, in the laminating process of the winding-up loading and unloading system in which the metal layer 21 and the near infrared ray shielding film 41 in the form of belt-like continuous films (webs) are fed and laminated while they run in the longer direction, if the width of the near infrared ray shielding film 41 is made smaller than that of the metal layer 21 to be equal to the adhesion application width, wherein the width refers to the size in the direction perpendicular to the direction in which the near infrared ray shielding film 41 and the laminate film containing the transparent substrate 11 and the metal layer 21 run, it is possible to expose, for grounding, at least one of two edge sections, stretching in the web-running direction, of the frame part 101. In this case, the other two edge sections, stretching perpendicularly to the web-running direction, of the frame part 101 are covered with the near infrared ray shielding film 41, and the portions of the near infrared ray shielding film 41 that cover these edge sections of the frame part 101 may be either left as they are or removed properly. Of course, a near infrared ray shielding film 41 with a greater width may be used, and the portion of the near infrared ray shielding film 41 that covers at least one edge section of the frame part 101 may be removed by a conventional half die cutting method or the like.

Further, it is possible to expose the two edge sections, stretching in the web-running direction, of the frame part 101 by applying an adhesive only to the mesh part 103 of the metal layer 21 and the two edge sections, stretching perpendicularly to the web-running direction, of the frame part 101, with the adhesive application width decreased at both width ends. In this case, if the width of the near infrared ray shielding film 41 is made smaller than that of the metal layer 21 to be equal to the adhesive application width, the frame part 101 (the two edge sections of the frame part 101) is not covered with the near infrared ray shielding film 41, so that the step of removing the near infrared ray shielding film 41 is unnecessary.

(Near Infrared Ray Shielding Film)

The near infrared ray shielding film 41 is a preformed film that absorbs at least near infrared rays with specific wavelengths. The specific wavelengths of near infrared rays are herein approximately 800 to 1100 nm. It is particularly desirable that the near infrared ray shielding film 41 absorbs 80% or more, more preferably 90% or more, of near infrared rays with wavelengths in the range of 800 to 1100 nm. The near infrared ray shielding film 41 that absorbs near infrared rays with the specific wavelengths to this extent can prevent malfunction of remotely controlled apparatus such as VTRs, and of infrared communications equipment.

It is preferable to use, for the near infrared ray shielding film 41, materials containing near infrared absorbers (referred to as “NIR absorbers”) that absorb near infrared rays with the specific wavelengths. Any near infrared absorber is herein useful, and it is possible to use colorants that show great absorption in the near infrared region, have high transmittance for light in the visible light range, and show no great absorption at the specific wavelengths in the visible light range. Generally, a great part of the light in the visible light range, emitted from PDPs, is orange light that is originated from the emission spectrum of neon atom, so that a colorant that absorbs light of approximately 590 nm may also be incorporated. Examples of colorants useful for the near infrared absorber include cyanine compounds, phthalocyanine compounds, immonium compounds, diimmonium compounds, naphthalocyanine compounds, naphthoquinone compounds, anthraquinone compounds, and dithiol complexes. These colorants may be used either singly or as a mixture of two or more colorants.

Such films as a film in which a colorant for the near infrared absorber is dispersed, and a film obtained by applying a colorant that has been made into ink along with a binder and drying the ink film, may be used as the near infrared ray shielding film 41, and examples of films useful for the near infrared ray shielding film 41 include commercially available films containing NIR absorbers (e.g., trade name No. 2832 manufactured by Toyobo Co., Ltd., Japan).

When the near infrared ray shielding film 41 is laminated to the metal layer 21 in the above-described manner, near infrared rays emitted from PDPs are absorbed, so that the malfunction of remotely controlled apparatus such as VTRs and of infrared communications equipment that are being used near the PDPs is avoidable.

When the near infrared ray shielding film 41 is laminated to the laminate of the transparent substrate 11/the first adhesive layer 13/the metal layer 21 (in the form of a mesh) by the second transparent adhesive layer 33 in the above-described manner, the surface irregularities of the first adhesive layer 13 exposed at the openings 105 of the mesh part 103 of the metal layer 21 are filled with the second transparent adhesive layer 33, whereby the exposed roughened surface R of the first adhesive layer 13 is smoothened.

The laminating of the near infrared ray shielding film 41 is conducted by dry laminating. The adhesive that is used to form the second adhesive layer 33 is of solvent-soluble type, and its viscosity is about 1 to 1000 cps. Therefore, the adhesive for the second adhesive layer 33 satisfactorily moistens a face to which the adhesive is applied, well spreads on the face, and, even if the face has irregularities, can fill the irregularities.

By so laminating the near infrared ray shielding film 41, the roughened surface R of the first adhesive layer 13 exposed at the openings 105 of the mesh part 103 of the metal layer 21, as shown in FIG. 5(B), is eliminated (the interface between the first adhesive layer 13 and the second adhesive layer 33 is optically eliminated), so that irregular reflection of light is suppressed. Therefore, even when the front panel is mounted on a display such as a PDP, the contrast of an image displayed on the display is enhanced, and the image visibility can thus be improved.

In a conventional display front panel, it has been unavoidable that air is incorporated in the openings of the mesh part to form air bubbles when laminating the metal mesh layer and the other member coated with a pressure-sensitive adhesive. For this reason, the step of removing the air bubbles by deaeration in order for the adhesive to spread to all the corners of the openings to become transparent has so far been specially effected. This step is a batch-wise process that is conducted in the following manner, for example: the display front panel is placed in a pressure-resistant, expensive closed vessel, such as an autoclave, is heated to a temperature of approximately 30 to 100° C., and is treated by either pressurizing or decompressing, or pressurizing and decompressing the closed vessel for a period of time as long as 30 to 60 minutes. On the contrary, such an inefficient step is not needed for the method for producing a display front panel according to this embodiment.

Further, the near infrared ray shielding film 41 is dry-laminated to the metal layer 21, and this laminating is usually conducted by the winding-up loading and unloading system in which continuous belt-like films (webs) are laminated while they run. Therefore, if the width, the size in the direction perpendicular to the running direction, of the near infrared ray shielding film 41 is made smaller than that of the metal layer 21, and the two films are laminated while they run, with the near infrared ray shielding film 41 offset toward one side or positioned in the center, it is possible to easily expose at least one edge section of the frame part 101 of the metal layer 21.

By causing the near infrared ray shielding film 41 and the laminate film containing the metal layer 21 to run, with the near infrared ray shielding film 41 offset toward one side, it is possible to expose the face of at least one of the upper, lower, right-hand, and left-hand sections of the frame part 101 surrounding the mesh part 103. By causing the near infrared ray shielding film 41 and the laminate film to run, with the near infrared ray shielding film 41 positioned in the center, it is possible to expose the faces of at least two of the upper, lower, right-hand, and left-hand sections of the frame part 101 surrounding the mesh part 103.

The frame part 101 of the metal layer 21 is thus exposed at least partially, and the exposed part can be used for grounding. It is therefore not necessary to make a terminal (by separately stripping and removing a coating, a film, or the like from the frame part of the metal layer) which has so far been conducted.

Further, although the step of laminating the near infrared ray shielding film 41 has so far been effected separately from the step of applying a transparent resin to the mesh part 103 of the metal layer 21, it is, in this embodiment, effected simultaneously with the step of smoothening the roughened surface R of the first adhesive layer 13 exposed at the openings 105 of the mesh part 103 of the metal layer 21, so that the number of the steps needed is smaller.

Furthermore, dry laminating is a basic technique for those skilled in the art, and the display front panel of the embodiment can be easily produced by dry laminating, using the existing facilities and techniques, with high productivity and high yields.

Furthermore, since a near infrared ray shielding film 41 preformed in a predetermined thickness is laminated by dry laminating, the near infrared ray absorbing layer is uniform in thickness, having no unevenness or in-plane variations in thickness, as shown in FIG. 5(C). It is therefore possible to solve the problem that a near infrared ray absorbing layer formed by coating cannot be uniform in thickness, as shown in FIG. 6(C).

Furthermore, in addition to dry laminating, photolithography is also a basic technique for those skilled in the art, so that the method of the invention is advantageous.

In all of the steps in the production method, it is possible to process a continuously roll-up, belt-like laminate while continuously or intermittently feeding it, as long as the transparent substrate 11 of the laminate is made from a flexible material. The display front panel can therefore be produced with high productivity in a smaller number of steps, two or more steps being collectively effected in one step, and moreover, the existing productive facilities can be used for production.

(Modified Embodiments)

The present invention encompasses the following modifications.

(1) The above embodiment has been described with reference to the case where the transparent substrate 11 and the near infrared ray shielding film 41 have flexibility and are processed by the winding-up loading and unloading system. However, in a case where they are not flexible, flat sheets may be used. In this case, the flat sheets cannot be continuously processed, but can be processed while they are intermittently fed, and there can be obtained the same effects and actions as those that are obtained when the sheets are processed by the winding-up loading and unloading system, except for the effects characteristically obtained when the process is conducted by the winding-up loading and unloading system.

(2) The display front panel 1 according to the above-described embodiment may be combined with non-limitative, various members, such as optical components having the function of preventing reflection and/or glaring of light, and reinforcements having mechanical strength. When the display front panel is combined with such members, the reflection of imaging light from a PDP and extraneous light entering the display from outside is suppressed, and the visibility of an image displayed on the display is thus improved. Moreover, it is possible to protect the display front panel from damage that is caused by external force.

### EXAMPLES

Specific examples of the above-described embodiment will be given hereinafter.

### Example 1

10-μm thick electrolytic copper foil in the form of a web, having, on one surface, a blackening layer made from copper-cobalt alloy particles, was prepared as the metal layer. A 100-μm thick biaxially oriented PET film A4300 (trade name of polyethylene terephthalate manufactured by Toyobo Co., Ltd., Japan) in the form of a web, having the same width as that of the electrolytic copper foil, was prepared as the transparent substrate. The transparent substrate and the metal layer (the blackening layer side) were dry-laminated with the first adhesive layer made of a layer of a transparent, two-pack curable urethane adhesive, and were then aged at 50° C. for 3 days, thereby obtaining a laminate. For the adhesive were used a main agent Takelack A-310 (trade name, manufactured by Takeda Chemical Industries, Ltd., Japan) consisting of polyester urethane polyol, and a curing agent A-10 (trade name, manufactured by Takeda Chemical Industries, Ltd., Japan) consisting of hexamethylene diisocyanate. The adhesive was applied in such an amount that the dried adhesive layer had a thickness of 7 μm.

The blackening layer/the metal layer in the laminate obtained in the above-described manner was photolithographically made into a mesh, thereby forming a pattern composed of a mesh part and a frame part, the planar view of the pattern being as shown in FIG. 1. Using the existing production line for shadow masks for color TVs, the laminate in the form of a continuous, belt-like web was subjected to a series of the steps of from masking to etching (effected by the winding-up loading and unloading system).

First, a casein negative photoresist was applied to the entire metal layer face of the laminate by flow coating. This laminate was intermittently carried to the next station, where the resist layer was subjected to contact exposure to light through a negative mesh pattern plate (consisting of line parts having transparency and openings having light-shielding properties). While transferring the laminate from one station to another, development with water, film hardening, and baking by heating were conducted. The baked laminate was further carried to the next station, where the laminate was etched by spraying an aqueous ferric chloride solution, an etchant, over the laminate to make openings in the laminate. While transferring the laminate from one station to another, washing with water, resist stripping, cleaning, and drying by heating were conducted, thereby obtaining a metal mesh layer composed of a mesh part having openings in the shape of regular squares, and a 15-mm wide frame part around the mesh part, the width of the lines defining the openings being 10 μm, the distance between the lines (line pitch) being 300 μm, the bias angle (the angle between the lines and the side of the substrate) being 49 degrees.

The same transparent, two-pack curable urethane adhesive as that used for the first adhesive layer was applied to the surface of the metal mesh layer formed in the above-described manner to form the second adhesive layer, which was then dried. To this second adhesive layer was laminated a preformed NIR film No. 2832 (trade name of a near infrared ray shielding film manufactured by Toyobo Co., Ltd., Japan), and this was aged at 50° C. for three days, thereby obtaining a laminate. The openings of the mesh part of the metal layer were thus filled with the two-pack curable urethane adhesive (for the second adhesive layer), so that the roughened surface of the first adhesive layer exposed at the openings was eliminated, and the surface of the second adhesive layer was covered with the near infrared ray shielding film uniform in thickness. There was thus obtained a display front panel with a flat and smooth surface having such a cross section as is shown in FIG. 5(C).

### Example 2

A display front panel was obtained in the same manner as in Example 1, except that the width of the NIR film was made 15 mm smaller than that of the metal layer, and that the transparent substrate and the metal layer were dry-laminated, with the two sheets aligned at one edge extending in the film-running direction. The display front panel obtained in this manner was that one edge section of the frame part of the metal layer was not covered with the NIR film and was exposed in a width of 15 mm.

### Example 3

A display front panel was obtained in the same manner as in Example 1, except that 10-μm thick electrolytic copper foil having, on each side, a blackening layer made from copper-cobalt alloy particles and an anticorrosive layer formed by chromate treatment was used as the metal layer.

(Evaluation)

The display front panels were evaluated in terms of haze, total luminous transmittance, visibility, ability to shield electromagnetic waves, and ability to shield near infrared rays.

The haze was determined in accordance with JIS-K7136, and the total luminous transmittance was measured in accordance with JIS-K7361-1, using a colorimeter HM150 (trade name, manufactured by Murakami Color Research Laboratory, Japan).

The visibility was evaluated in the following manner: the display front panel was mounted on the front of a PDP, “WOOO” (trade name, manufactured by Hitachi, Ltd., Japan), and a test pattern, a white solid image, and a black solid image were successively displayed on the display screen and were visually observed at a point 50 centimeters distant from the display, at viewing angles of 0 to 80 degrees. Specifically, observations were made on brightness, contrast, the reflection and glaring of extraneous light at the time of black displaying, and the unevenness of the blackening layer at the time of white displaying.

The ability to shield electromagnetic waves was determined by the KEC method (a method of measuring electromagnetic waves, developed by Kansai Electronic Industry Development Center, Japan).

The ability to shield near infrared rays was determined by a spectrophotometer “best-570” (manufactured by Nippon Bunko Kabushiki Kaisha, Japan).

As a result, the display front panels of Examples 1 and 2 had a haze value of 2.1 and a total luminous transmittance of 58.2, and were excellent also in visibility.

The display front panel of Example 3 was equal to that of Example 1 in haze value and total luminous transmittance, but was superior to it in visibility.

As for the ability to shield electromagnetic waves, all of the display front panels of Examples 1 to 3 attenuated, at rates of 30 to 60 dB, electromagnetic waves having frequencies of 30 MHz to 1000 MHz and were thus confirmed to have satisfactorily excellent electromagnetic wave shielding properties.

Further, as for the ability to shield near infrared rays, the entire mesh parts of the display front panels of Examples 1 to 3 transmitted 10% to 5% of light with wavelengths of 800 to 1100 nm; these transmittances were sufficient, and the scatter in transmittance was few.

1. A method for producing a display front panel comprising a transparent substrate, a metal mesh layer laminated to at least one surface of the transparent substrate by a first transparent adhesive layer, and a near infrared ray shielding film laminated to the surface of the metal mesh layer by a second transparent adhesive layer, comprising the steps of:
(1) laminating a metal layer to at least one surface of a transparent substrate by a first transparent adhesive layer, thereby obtaining a laminate,
(2) providing a mesh-patterned resist layer on the metal layer face of the laminate, etching the metal layer to remove portions thereof that are not covered with the resist layer, and removing the resist layer, thereby forming a metal mesh layer having a mesh part with a plurality of openings, and a frame part around the mesh part, and
(3) laminating a near infrared ray shielding film to the face of the mesh part of the metal mesh layer by a second transparent adhesive layer, and filling the surface irregularities of the first adhesive layer exposed at the openings of the mesh part with the second adhesive layer to make the exposed roughened surface of the first adhesive layer transparent.

2. The method according to claim 1, wherein both the laminating of the metal layer to the transparent substrate and the laminating of the near infrared ray shielding film to the metal layer are conducted by dry laminating wherein continuous films are laminated by a winding-up loading and unloading system.

3. The method according to claim 2, wherein, in laminating the near infrared ray shielding film to the metal layer face by the winding-up loading and unloading system, at least one edge section of the frame part of the metal layer is exposed by making a width of the near infrared ray shielding film smaller than that of the metal layer in the laminate film, wherein the width refers to a size in a direction perpendicular to a direction in which the near infrared ray shielding film and the laminate film containing the metal layer run.

4. A display front panel comprising:
a transparent substrate,
a metal mesh layer laminated to at least one surface of the transparent substrate by a first transparent adhesive layer, and
a near infrared ray shielding film laminated to a surface of the metal mesh layer by a second transparent adhesive layer,
the metal mesh layer having a mesh part with a plurality of openings, the second adhesive layer filling surface irregularities of the first adhesive layer exposed at the openings of the mesh part to make the exposed roughened surface of the first adhesive layer transparent.

5. The display front panel according to claim 4, wherein the metal mesh layer further has a frame part around the mesh part, and at least one edge section of the frame part is exposed without being covered with the near infrared ray shielding film.
